(19) United States
(12) Patent Application Publication
(10) Pub. No.: US 2012/0113969 A1
(43) Pub. Date: May 10, 2012

(54) PORTABLE ROUTER DEVICE

(75) Inventor: Takashi ISHIDOSHIRO, Nagoya-shi (JP)

(73) Assignee: Buffalo Inc., Nagoya-shi (JP)

(21) Appl. No.: 13/267,335

(22) Filed: Oct. 6, 2011

(30) Foreign Application Priority Data
Oct. 6, 2010 (JP) 2010-226543

(51) Int. Cl. H04W 80/00

(52) U.S. Cl. 370/338

(57) ABSTRACT

A portable router device for relaying a packet exchanged between a wide area network (WAN) and a local are network (LAN) device includes a WAN communication unit for connecting and communicating with the WAN, a LAN communication unit for connecting and communicating with the LAN device, and an application data converter for converting application data included in the packet transmitted from the WAN to the LAN device.

### CROSS REFERENCE TO RELATED APPLICATION

This application is based upon and claims the benefit of priority from, the prior Japanese Patent Application No. 2010-226543 filed on Oct. 6, 2010; all the contents of which are incorporated herein by reference.

### BACKGROUND OF INVENTION

1. Field of Invention

This invention relates to a portable router device relaying packets exchanged between a WAN and a LAN device.

2. Descriptions of the Related Art

Electronic devices usable with wireless Local Area Network (LAN), i.e. wireless LAN devices, have been widely disseminated in recent years. Generally, a wireless LAN device cannot access the Internet when there is no connectable wireless LAN access point nearby (for example, in a place away from home or the like).

Portable router devices have been put into practice to allow the wireless LAN device to access the Internet even in places away from home or the like. The portable router has a function of connecting with a cellular phone network and a function of connecting with the wireless LAN device, and relays packets exchanged between the cellular phone network and the wireless LAN device (for example, see Japanese Patent Application Publication No. 2009-303234).

### SUMMARY OP INVENTION

The wireless LAN devices sometimes have limitations in executable application format due to their performances lower than those of stationary LAN devices. For example, some wireless LAN devices do not support Flash format as it leads to large power consumption, or do not support H.264 format as it doesn't allow a sufficient processing capacity.

For these reasons, the user of the wireless LAN device cannot use a service using an application format that is not supported by the wireless LAN device. Hence, usability is impaired.

An object of this invention is to provide a portable router device capable of improving the usability of a LAN device such as a wireless LAN device.

According to one of the features of this invention, there is provided a portable router device for relaying a packet exchanged between a wide area network (WAN) and a local are a network (LAN) device, comprising: a WAN communication unit for connecting and communicating with the WAN; a LAN communication unit for connecting and communicating with the LAN device; and an application data converter for converting application data included in the packet transmitted from the WAN to the LAN device.

According to the feature described above, the portable router device converts the application data included in the packet transmitted from the WAN to the LAN device. Thus, the portable router device can relay the application data to the LAN device in a form executable by the LAN device. Accordingly, the usability of the LAN device such as a wireless LAN device can be improved.

According to another feature of this invention, the portable router device further comprises: an address converter for converting an Internet protocol (IP) address included in the packet exchanged between the WAN and the LAN device.

According to another feature of this invention, the address converter performs conversion of a global IP address to a local IP address, and a local IP address to a global IP address.

According to the features described above, the LAN device such as the wireless LP device having no global IP address can access the Internet.

According to another feature of this invention, the WAN communication unit connects and communicates with a cellular phone network serving as the WAN, and the LAN communication unit connects and communicates with a wireless LAN device serving as the LAN device.

According to the feature described above, the wireless LAN device can access the Internet via the cellular phone network.

According to another feature of this invention, the portable router device further comprises: a storage unit for storing an association between a conversion target application format and a conversion destination application format; and an identifying unit which refers to the storage unit and indentifies the conversion destination application format of the application data included in the packet transmitted from the WAN to the LAN device, wherein the application data converter converts the application data included in the packet transmitted from the WAN to the LAN device, to the identified conversion destination application format.

According to the feature described above, the conversion destination application format can be set for each application format. Thus, various application formats can be flexibly handled.

According to another feature of this invention, the portable router device further comprises: a storage unit for storing an association between a conversion target application format and a conversion destination application format for each of plural LAN devices, an identifying unit which, in response to an access from one of the plural LAN devices, refers to the association for the one LAN device in the storage unit to identify the conversion destination application format of the application data included in the packet transmitted from the WAN to the LAN device, wherein the application data converter converts the application data included in the packet transmitted from the WAN to the LAN device, to the identified conversion destination application format.

According to the feature described above, even when various LAN devices are connected to the portable router device, the conversion destination application format can be set for each LAN device and each application format. Thus, various LAN devices and various application formats can be flexibly handled.

### BRIEF DESCRIPTION OF DRAWINGS

FIG. 1 illustrates a communication system including a portable router device as a first embodiment of this invention.

FIG. 2A schematically shows the internal design of the portable router device of the first embodiment.

FIG. 2B shows a table stored in a storage unit of the portable router device of the first embodiment.

FIG. 3 is the flowchart of an operation related to application conversion of the portable router device of the first embodiment.

FIG. 4 shows tables stored in the storage unit of a portable router device as a second embodiment of this invention.

FIG. 5 is the flowchart of an operation related to application conversion of the portable router device of the second embodiment.

### DESCRIPTION OF EMBODIMENTS

A first embodiment, a second embodiment, and other embodiments of this invention are described with reference to the drawings. In the drawings showing the embodiments below, the same or similar components are labeled with the same or similar reference numerals.

### (1) First Embodiment

The first embodiment is described below in the order of (1.1) Overall Schematic Design, (1.2) Design of Router Device, (1.3) Operation Example of Router Device, and (1.4) Effects of First Embodiment.

(1.1) Overall Design

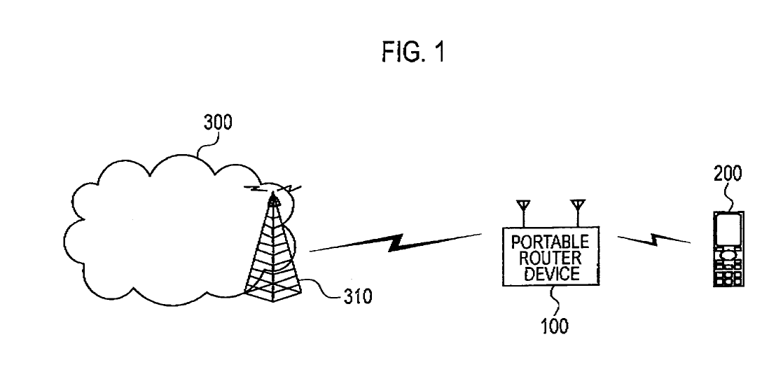

FIG. 1 illustrates the entire system including a portable router device 100 of the first embodiment.

As shown in FIG. 1, the portable router device 100 is connected to and communicates with a cellular phone network 300, and is also connected to and communicates with a wireless LAN device 200.

Moreover, the portable router device 100 relays packets exchanged between the cellular phone network 300 and the wireless LAN device 200. Here, the packets are IP packets and each consist of a header which includes a destination XP address and a transmission source IP address; and a payload which includes application data.

The cellular phone network 300 is a WAN complying with 3rd generation cellular communications, and includes a radio base station 310. The cellular phone network 300 is connected to the Internet.

The wireless LAN device 200 is a portable device such as a tablet device or a notebook PC which has a function of connecting with wireless LAN, and is capable of executing an application.

(1.2) Design of Router Device

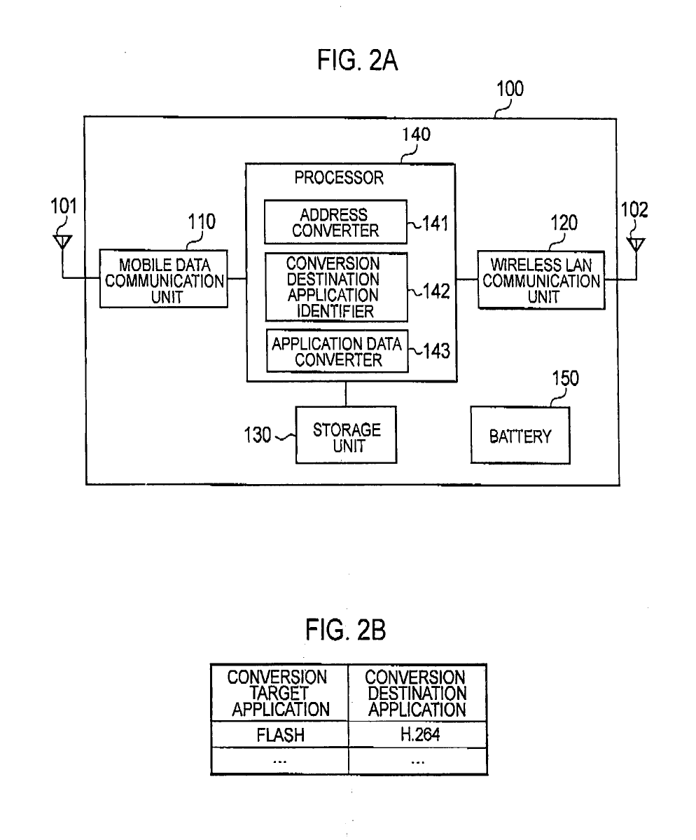

Next, the design of the portable router device 100 of the first embodiment is described using FIG. 2. FIG. 2A shows in block diagram the internal design of a portable router device of the first embodiment.

As shown in FIG. 2A, the portable router device 100 includes an antenna 101, an antenna 102, a mobile data communication unit 110, a wireless LAN communication unit 120, a storage unit 130, a processor 140, and a battery 150. The mobile data communication unit 110, the wireless LAN communication unit 120, and the storage unit 130 are electrically connected to the processor 140.

The antenna 101 is used to transmit and receive radio signals to and from the radio base station 310. The mobile data communication unit 110 has a reception function of amplifying and down-converting and then demodulating the radio signals received by the antenna 101, and a transmission function of modulating and then up-converting and amplifying transmission signals. In the first embodiment, the mobile data communication unit 110 corresponds to a WAN communication unit. For example, 3G, Long Term evolution (LTE), LTE-Advanced, TD-LTE, WiMAX, High Speed Packet Access (HSPA), and IEEE802.16m are given as examples of the standards of the cellular communication (mobile data communication).

The antenna 102 is used to transmit and receive radio signals to and from the wireless LAN device 200. The wireless LAN communication unit 120 has a reception function of amplifying and down-converting and then demodulating the radio signals received by the antenna 102, and a transmission function of modulating and then up-converting and amplifying transmission signals. In the first embodiment, the wireless LAN communication unit 120 corresponds to a LAN communication unit. For example, IEEE802.11 is given as an example of the standard of the wireless LAN communication.

The storage unit 130 is, for example, a semiconductor memory such as a DRAM or a flash memory, and stores programs to be executed by the processor 140 and various types of data to be used in the processing by the processor 140. The processor 140 is, for example, a processor such as a CPU or a DSP, and executes the programs stored in the storage unit 130. The battery 150 supplies power to the mobile data communication unit 110, the wireless LAN communication unit 120, the storage unit 130, and the processor 140.

The processor 140 provides the functions of an address converter 141, a conversion destination application identifying unit 142, and an application data converter 143 by executing the programs stored in the storage unit 130.

The address converter 141 converts IP addresses included in packets exchanged between the cellular phone network 300 and the wireless LAN device 200. To be more specific, the address converter 141 has a Network Address Translation (NAT) function, i.e. performs conversion of a global IP address to a local IP address, and a local IP address to a global IP address.

The address converter 141 converts the transmission source IP address from the local IP address to the global IP address, for a packet transmitted from the wireless LAN device 200 to the cellular phone network 300. Furthermore, the address converter 141 converts the destination IP address from the global IP address to the local IP address, for a packet transmitted from the cellular phone network 300 to the wireless LAN device 200.

The conversion destination application identifying unit 142 refers to the storage unit 130 and identifies the application format to which the application data included in the packet transmitted from the cellular phone network 300 to the wireless LAN device 200 is to be converted.

FIG. 2B shows a table stored in the storage unit 130 of the portable router device 100 of the first embodiment.

As shown in FIG. 2B, the storage unit 130 stores the table in which a conversion target application format and a conversion destination application format are associated with each other. In the example of FIG. 2B, the conversion target application format represented as “Flash” is associated with the conversion destination application format represented as “H.264”. Here, when application data of the Flash format is included in packets (packet group) transmitted from the cellular phone network 300 to the wireless LAN device 200, the conversion destination application identifying unit 142 indentifies “H.264” as the conversion destination application format.

Note that, the portable router device 100 may have the table stored in the storage unit 130 set in advance from the wireless LAN device 200, or from the cellular phone network 300 by using Web setting of a PC or the like.

The application data converter 143 converts application data which is the conversion target included in the packets (packet group) transmitted from the cellular phone network 300 to the wireless LAN device 200, to the conversion destination application format identified by the conversion destination application identifying unit 142. To be specific, the application data converter 143 extracts the application data from the packets (packet group) inputted from the mobile data communication unit 110, converts the data, and thereafter outputs the packets (packet group) including the converted application data to the wireless LAN communication unit 120.

(1.3) Operation Example of Router Device

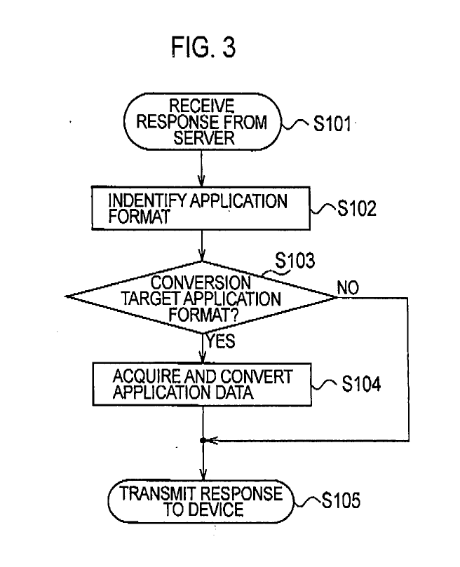

Next, an operation related to application conversion among operations of the portable router device 100 of the first embodiment is described in reference to FIG. 3. FIG. 3 is the flowchart of an operation related to application conversion of the portable router device 100 of the first embodiment.

As shown in FIG. 3, in Step S101 the mobile data communication unit 110 receives a response from a server on the Internet. Note that, the response is one which is transmitted by the server in response to a request from the wireless LAN device 200, and is a packet including application data. The packet includes information for indentifying the application data.

In Step S102, the conversion destination application identifying unit 142 indentifies the application format of the application data transmitted from the server on the basis of the information included in the response.

In Step S103, the conversion destination application identifying unit 142 judges whether or not the indentified application format is the conversion target application format (for example “Flash format”) by referring to the storage unit 130. To be specific, the conversion destination application identifying unit 142 judges whether or not the identified application format is the application format registered as the conversion target in the table stored in the storage unit 130.

If the identified application format is the application format registered as the conversion target in the table stored in the storage unit 130 (Step 103; YES), the application data converter 143 converts, in Step S104, application data which is the conversion target included in the packets (packet group) transmitted from the cellular phone network 300 to wireless LAN device 200, to the conversion destination application format identified by the conversion destination application identifying unit 142.

In Step S105, the wireless LAN communication unit 120 sends to the wireless LAN device 200 a response in the form of a packet including application data.

(1.4) Effects of First Embodiment

As described above, according to the first embodiment, the portable router device 100 converts the application data included in the packets transmitted from the cellular phone network 300 to the wireless LAN device 200. Thus, the portable router device 100 can relay application data to the wireless LAN device 200 in a form executable by the wireless LAN device 200. Accordingly, the usability of the wireless LAN device 200 can be improved.

Moreover, in the portable router device 100, the address converter 141 performs conversion of the global IP address to the local IP address, and the local IP address to the global IP address. Thus, the wireless LAN device 200 such as the wireless LAN device 200 not having the global IP address can access the Internet.

Moreover, in the portable router device 100, the mobile data communication unit 110 is connected to and communicates with the cellular phone network 300, and the wireless LAN communication unit 120 is connected to and communicates with the wireless LAN device 200. Thus, the wireless LAN device 200 can access the Internet via the cellular phone network 300.

In the first embodiment, the application data converter 143 converts the application data included in the packets transmitted from the cellular phone network 300 to the wireless LAN device 200, to the conversion destination application format identified by the conversion destination application identifying unit 142. Accordingly, the conversion destination application format can be set for each application format. Thus, various application formats can be flexibly handled.

### (2) Second Embodiment

Regarding the second embodiment, the difference from the first embodiment is described. The second embodiment is described below in the order of (2.1) Design of Router Device, (2.2) Operation Example of Router Device, and (2.3) Effects of Second Embodiment.

(2.1) Design of Router Device

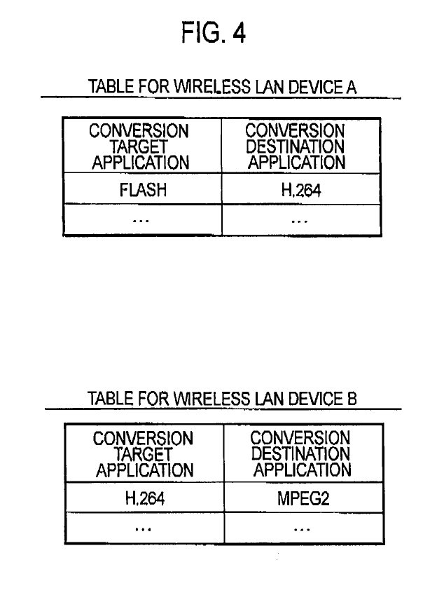

The design of the portable router device 100 of the second embodiment is described in reference to FIG. 2A and FIG. 4. FIG. 4 shows tables stored in the storage unit 130 of the portable router device 100 of the second embodiment.

As shown in FIG. 4, in the second embodiment, the storage unit 130 stores an association between a conversion target application format and a conversion destination application format for each of plural wireless LAN devices 200. For example, the storage unit 130 stores the association between the conversion target application format and the conversion destination application format for each of MAC addresses of the respective plural wireless LAN devices 200.

In the example of FIG. 4, the conversion target application format represented as “Plash” is associated with the conversion destination application format represented as “H.264” in table for a wireless LAN device “A”. Meanwhile, the conversion target application format “H.264” is associated with the conversion destination application format “MPEG2” in table for wireless LAN device “B”.

Note that, the portable router device 100 may have the table stored in the storage unit 130 set in advance from the wireless LAN device 200, or from the cellular phone network 300 by using Web setting of a PC or the like.

In response to an access from one wireless LAN device 200, the conversion destination application identifying unit 142 refers to the table corresponding to the one wireless LAN device 200 in the storage unit 130. For example, the conversion destination application identifying unit 142 extracts a MAC address included in a packet from the one wireless LAN device 200, and selects the table associated with the MAC address from the storage unit 130. Then, the conversion destination application identifying unit 142 uses the selected table to identify the conversion destination application format of the application data included in the packet transmitted from the cellular phone network 300 to the wireless LAN device 200.

The application data converter 143 converts application data which is the conversion target included in the packets (packet group) transmitted from the cellular phone network 300 to wireless LAN device 200, to the conversion destination application format identified by the conversion destination application identifying unit 142.

(2.2) Operation Example of Router Device

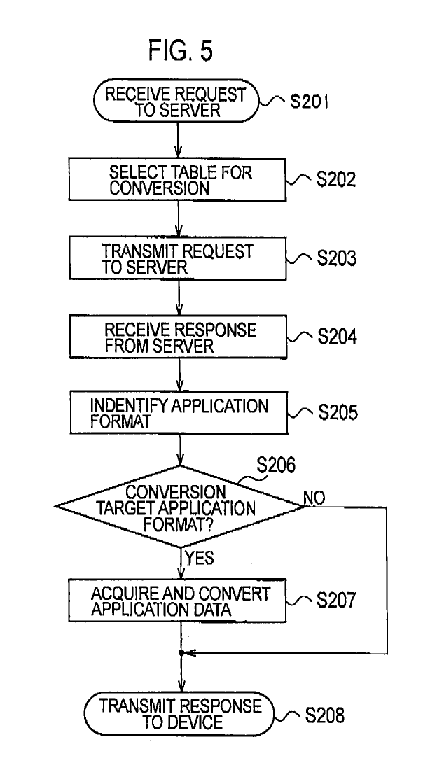

Next, an operation related to application conversion among operations of the portable router device 100 of the second embodiment is described in reference to FIG. 5. FIG. 5 is the flowchart of an operation related to application conversion of the portable router device 100 of the second embodiment.

As shown in FIG. 5, in Step S201 the wireless LAN communication unit 120 receives a request from the wireless LAN device 200. Note that, the request is to demand the server to transmit the application data, and is a packet including the MAC address of the wireless LAN device 200 serving as the transmission source.

In Step S202, the conversion destination application identifying unit 142 extracts the MAC address included in the packet inputted from the wireless LAN communication unit 120, and selects the table associated with the MAC address from the storage unit 130.

In Step S203, the mobile data communication unit 110 transmits the request received by the wireless LAN communication unit 120.

In Step S204, the mobile data communication unit 110 receives a response from a server. Note that, the response is transmitted by the server in response to the request from the wireless LAN device 200, and is a packet including application data. The packet includes information for indentifying the application data.

In Step S205, the conversion destination application identifying unit 142 indentifies the application format of the application data transmitted from the server by using the information included in the response.

In Step S206, the conversion destination application identifying unit 142 refers to the table selected in Step S202, and judges whether or not the identified application format is the conversion target application format. To be specific, the conversion destination application identifying unit 142 judges whether or not the indentified application format is the application format registered as the conversion target in the table selected in Step S202.

If the identified application format is the application format registered as the conversion target in the table selected in Step S202 (Step 206; YES), the application data converter 143 converts, in Step S207, application data which is the conversion target included in packets (packet group) transmitted from the cellular phone network 300 to the wireless LAN device 200, to the conversion destination application format identified by the conversion destination application identifying unit 142.

In Step S208, the wireless LAN communication unit 120 sends to the wireless LAN device 200 a response which is a packet including application data.

(2.3) Effect of Second Embodiment

The second embodiment can produce the following effect in addition to the effects described regarding the first embodiment.

To be specific, even when various wireless LAN devices 200 are connected to the portable router device 100, the conversion destination application format can be set for each wireless LAN device 200 and for each application format. Thus, various wireless LAN devices 200 and various application formats can be flexibly handled.

### (3) Other Embodiments

As described above, the details of this invention have been disclosed by using the embodiments of this invention. However, it should not be understood that the description and drawings which constitute part of this disclosure limit this invention. From this disclosure, various alternative embodiments, examples, and operation techniques will be easily found by those skilled in the art.

In each of the embodiments described above, the portable router device 100 includes the mobile data communication unit 110 which can be connected to and communicate with the cellular phone network 300 serving as the WAN. However, the portable router device 100 may include a wired WAN communication unit which can be connected to and communicate with a wired WAN.

Moreover, in each of the embodiments described above, the portable router device 100 includes the wireless LAN communication unit 120 which can be connected to and communicate with the wireless LAN device 200 serving as the LAN device. However, the portable router device 100 may include a wired LAN communication unit which can be connected to and commutate with a wired LAN.

Furthermore, in each of the embodiments described above, the portable router device 100 converts the application formats. However, the portable router device 100 may convert not only the application formats but also the compression ratio (or the data rate) of application data.

In this manner, this invention naturally includes various embodiments not specifically described herein.

What is claimed is:

1. A portable router device for relaying a packet exchanged between a wide area network (WAN) and a local are network (LAN) device, comprising:
a WAN communication unit for connecting and communicating with the WAN;
a LAN communication unit for connecting and communicating with the LAN device; and
an application data converter for converting application data included in the packet transmitted from the WAN to the LAN device.

2. The portable router device according to claim 1, further comprising:
an address converter for converting an Internet protocol (IP) address included in the packet exchanged between the WAN and the LAN device.

3. The portable router device according to claim 2, wherein
the address converter converts a global IP address to a local IP address, and a local IP address to a global IP address.

4. The portable router device according to claim 1, wherein
the WAN communication unit connects and communicates with a cellular phone network serving as the WAN, and
the LAN communication unit connects and communicates with a wireless LAN device serving as the LAN device.

5. The portable router device according to claim 1, further comprising:
a storage unit for storing an association between a conversion target application format and a conversion destination application format; and
an identifying unit which refers to the storage unit and indentifies the conversion destination application format of the application data included in the packet transmitted from the WAN to the LAN device, wherein
the application data converter converts the application data included in the packet transmitted from the WAN to the LAN device, to the identified conversion destination application format.

6. The portable router device according to claim 1, further comprising:
a storage unit for storing an association between a conversion target application format and a conversion destination application format for each of plural LAN devices,
an identifying unit which, in response to an access from one of the plural LAN devices, refers to the association for the one LAN device in the storage unit to identify the conversion destination application format of the application data included in the packet transmitted from the WAN to the LAN device, wherein
the application data converter converts the application data included in the packet transmitted from the WAN to the LAN device, to the identified conversion destination application format.
